(19) United States
(12) Patent Application Publication
(10) Pub. No.: US 2026/0290287 A1
(43) Pub. Date: Sep. 24, 2026

(54) A VALVE ASSEMBLY FOR A BRASS INSTRUMENT

(71) Applicant: GENEVA INSTRUMENTS LIMITED, Middlesbrough (GB)

(72) Inventors: Vincent Eckerman, Middlesbrough (GB); Paul Brooker, Middlesbrough (GB)

(73) Assignee: GENEVA INSTRUMENTS LIMITED, Middlesbrough (GB)

(21) Appl. No.: 19/168,745

(22) PCT Filed: Mar. 25, 2024
(86) PCT No.: PCT/GB2024/050794

§ 371 Date: Sep. 24, 2025

(30) Foreign Application Priority Data
Mar. 24, 2023 (GB) 2304331.8

(51) Int. Cl. G10D 9/04; G10D 7/10; G10D 9/08

(52) U.S. Cl. CPC G10D 9/04; G10D 7/10; G10D 9/08

(57) ABSTRACT

A valve assembly for a brass instrument is disclosed. The assembly has a valve block with substantially cylindrical apertures for receiving pistons therein. Each piston is cylindrical and is machined from a block of metal and has three ports formed through the cylindrical block. The curved surface has a first surface portion for engaging an internal surface of the valve block and has second surface portions radially inward of the first surface portions. The first surface portions extend around ports and the second surface portions are located between the ports and the ends of the pistons.

The present invention relates to a valve assembly for a brass instrument and to a method of making such a valve assembly and relates particularly, but not exclusively, to a valve block and pistons for a trumpet.

A valve assembly for a brass instrument, such as a trumpet, cornet or tuba, has a series of three pistons held in a valve block. Each piston has three holes in it which connect different valve slides (pipes) to vary the overall length of the airway from mouthpiece to bell and thereby change the note being played.

The production of the valve assembly of a brass instrument requires the use of precise production techniques to ensure the smooth movement of pistons and the unrestricted passage of air within the valve block. Traditionally, this has involved the brazing of different tubes together to form the valve block and to form the holes within the pistons. Because all of these components are made from tubes of metal (typically brass), such valve assemblies are light in weight which is important for the players as they must hold their instruments up to their mouths in order to play. The manufacture of the valve block involves brazing short sections of pipe to act as connectors to the larger tubes which contain the pistons. This is done by brazing together the tubes of brass and requires a great deal of skill and precision. Once brazed together the components also require skilled finishing in order to ensure the smooth movement of the pistons and airflow within the block.

The techniques for making the pistons in the prior art also involve a process of brazing and do so by joining short sections of a narrow tubing inside a single section of larger tube. The junctions are brazed, the smaller tubes are bent into shape and are in very close proximity to each other making it very difficult to produce consistently identical air pathways through the pistons. Even though the apertures through the piston only represents a small portion of the overall length of the air passage through the instrument, this can affect the air flow and in particular the free blowing of the instrument. Part of the process of finishing the apertures, or ports, in the pistons involves the pushing of a metal ball on a stick through the tube that forms the port. Pushing this tool through the port removes any deformations in the tubes which have been introduced in the manufacturing process and forces the tube into a uniform cross-section. However, due to the close proximity of the tubes to each other, as one tube is improved using this process it can press onto and distort an adjacent tube. As a result, at least one of the tubes includes at least one slight deformation which can impact the free blowing of the instrument.

In all traditional valved brass instruments, the components require the lubrication of oil and the consistency of this oil is dependent on the environmental temperature the instrument is being played in. As a result, lubricant properties can change when players move from playing indoors to outdoors.

Alternative manufacturing methods have been proposed but none have combined the factors of being formed from metal, being light weight, unrestricted airflow, having improved sound and playability, requiring reduced lubrication, and an improved quality of manufacturing leading to sensations for the player which are not a compromise and feel like existing high quality instruments. An example of such an instrument of the prior art is disclosed in U.S. Pat. No. 4,210,056. This document discloses a method for manufacturing a valve for a brass instrument using solid pistons. However, valve pistons disclosed therein are primarily formed from thermoplastic materials and are not suitable for use in instruments for more advanced standard musicians. Other examples of the prior art are disclosed in the document published under the following numbers US2022398999, CN204904811U, US2015114203, US2019287498, GB1140117, U.S. Pat. No. 2,259,756, US2006219083, BRPI10603510, US2015317961 and U.S. Pat. No. 4,127,052.

Preferred embodiments of the present invention seek to overcome or alleviate the above described disadvantages of the prior art.

According to an aspect of the present invention there is provided a valve assembly for a brass instrument, the assembly comprising:
a valve block having a plurality of substantially cylindrical apertures for receiving valve pistons therein;
a plurality of valve pistons, wherein each piston is formed by removal of material from a block of metal, each piston is substantially cylindrical, having a curved surface between opposing ends of said cylindrical form and having a plurality of air flow apertures extending between portions of said curved surface, wherein said curved surface has a first surface portion for engaging an internal surface of said valve block apertures and said second surface portions radially inward of said first surface portions, wherein said first surface portions extend around said air flow apertures and said second surface portions are located between said air flow apertures and said ends.

By producing the pistons using a machining process of removing material from a block of metal and in particular providing first and second portions to the curved surface the advantage is provided that the surface contact between the piston and valve block is reduced but the overall weight of the valve block is not increased significantly. As a result, the instrument is improved while maintaining the playability of the instrument to the standards expected by experienced musicians. For example, machining the air flow apertures or ports of the pistons improves the shape of those holes meaning that perfectly shaped ports can be formed with uniform circular cross-sections in the pistons every time. This improvement in the shape of the ports in turn improves the free blowing of the instrument, that is, the way in which the air flows through the instrument from mouthpiece to bell. Improved air flow through the instrument also results in improved sound quality. The reduced surface contact means that lubricant can be reduced or eliminated and ensures the free movement of the pistons within the valves in line with the playing experience of high standard instruments of the prior art.

In a preferred embodiment, the first surface is radially outwards of said second surface by at least one millimetre.

Having the second (radially inner) portion of the cylindrical surface one or more millimetres inward of the first portion, that engages the valve block aperture surface, provides the advantage of significantly reducing the weight of the piston to a point that is comparable with the weight of the traditionally made pistons.

In another preferred embodiment the valve piston comprises titanium or lightweight alloys.

Forming the piston from titanium or lightweight alloys further decreases the weight of these components of the valve assembly.

In a further preferred embodiment the pistons comprise third surface portions located adjacent said ends and radially equal to said first surface portions and the third surface portions may be located distal of finger buttons of said valve assembly.

Providing third surface portions at the bottom of the pistons that are also engaging the internal surface of the valve block provides the advantage of further stabilising the piston within the aperture of the valve block.

In a preferred embodiment the first surface portions of said pistons are coated with a ceramic material.

Coating the portions of the pistons that engage the valve block with a ceramic material further reduces the friction between the engaged surfaces and reduces, or even eliminates, the need for valve lubricant.

In another preferred embodiment the valve block is formed by removal of material from a block of metal.

The valve block may comprise a plurality of pipe connectors to allow connection of said valve blocks to connecting pipes (including the lead pipe and valve slides) of the instrument by soldering.

By forming the whole valve block, including the pipe connectors, the short pipes which are used to join the other pipes of the instrument to the valve block, buy a machining process of removing material from a larger block of metal, the advantages provided that all of the production steps which in the prior art required brazing are eliminated and the whole instrument can be formed using only soldering to join the parts of the instrument together. This significantly reduces the labour intensive aspects of the production of a brass musical instrument and also helps to improve the flow of air through the instrument as well as improving consistency in the production of the instruments. The process of brazing two parts of a soldering which requires less heat to form the joint. As a result, components can be formed with greater consistency using techniques of the prior art.

In a preferred embodiment the valve block comprises brass.

In another preferred embodiment the internal surface of said cylindrical apertures are coated with a ceramic material.

By applying a ceramic coating to the internal surface of the valve block apertures and in particular where this is combined with an equivalent coating on the pistons, the friction between the surfaces of the valves is sufficiently reduced to eliminate the need for a valve lubricant to be used.

According to another aspect of the present invention, there is provided a piston for a valve assembly for a brass instrument, wherein the piston is formed by removal of material from a block of metal, is substantially cylindrical, has a curved surface between opposing ends of said cylindrical form and has a plurality of air flow apertures extending between portions of said curved surface, wherein said curved surface as a first surface portion for engaging an internal surface of a valve block and said second surface portions radially inward of said first surface portions, wherein said first surface portions extend around said air flow apertures and said second surface portions are located between said air flow apertures and said ends.

In a preferred embodiment the first surface is radially outwards of said second surface by at least one millimetre.

In another preferred embodiment the valve piston comprises titanium.

The pistons my further comprise third surface portions located adjacent said ends and radially equal to said first surface portions.

In a preferred embodiment the third surface portions are located distal of finger buttons of said valve assembly.

In another preferred embodiment the first surface portions of said pistons are coated with a ceramic material.

According to a further aspect of the present invention, there is provided a valve block for a valve assembly for a brass instrument, wherein said valve block is formed by removal of material from a block of metal, has a plurality of substantially cylindrical apertures for receiving valve pistons therein and a plurality of pipe connectors to allow connection of said valve blocks to connecting pipes of the instrument by soldering.

In a preferred embodiment the valve block is formed by removal of material from a block of metal.

In another preferred embodiment the valve block comprises a plurality of pipe connectors to allow connection of said valve blocks to connecting pipes of the instrument by soldering.

In a further preferred embodiment the valve block comprises brass.

In a preferred embodiment the internal surface of said cylindrical apertures are coated with a ceramic material.

According to another aspect of the present invention, there is provided a brass instrument comprising:
mouth pipe;
a valve assembly as set out above;
a bell; and
a plurality of pipes connecting the mouth pipe to the bell via the valve assembly.

According to a further aspect of the present invention, there is provided a method of making a piston for a valve assembly for a brass instrument, comprising:
removing material from a block of metal to form a substantially cylindrical piston, having a curved surface between opposing ends of said cylindrical form wherein said removal of material forms a first surface portion of said curved surface for engaging an internal surface of a valve block and further removal of material forms second surface portions, radially inward of said first surface portions;
forming a plurality of air flow apertures extending between portions of said curved surface, wherein said first surface portions extend around said air flow apertures and said second surface portions are located between said air flow apertures and said ends.

According to another aspect of the present invention, there is provided a method of making a valve block for a valve assembly for a brass instrument comprising removing material from a block of metal to form a plurality of substantially cylindrical apertures for receiving valve pistons therein and removing material to form a plurality of pipe connectors to allow connection of said valve blocks to connecting pipes of the instrument by soldering.

According to a further aspect of the present invention, there is provided a method of making a valve assembly for a brass instrument comprising:
making a plurality of pistons as set out above;
making a valve block as set out above; and
inserting said pistons into said valve block.

According to another aspect of the present invention, there is provided a method of making a brass instrument comprising:
mouth pipe;
making a valve assembly as set out above;
attaching a mouth pipe to said valve assembly; and
attaching a plurality of pipes connecting the valve assembly to a bell.

According to a further aspect of the present invention, there is provided a piston for a valve assembly for a brass instrument, the piston comprising: a substantially cylindrical curved surface extending between opposing ends of said cylindrical form and has a plurality of air flow apertures extending between portions of said curved surface, wherein said curved surface as a first surface portion for engaging an internal surface of a valve block and said second surface portions radially inward of said first surface portions, wherein said first surface portions extend around said air flow apertures and said second surface portions are located between said air flow apertures and said ends.

Preferred embodiments of the present invention will now be described, by way of example only, and not in any limitative sense with reference to the accompanying drawings in which:

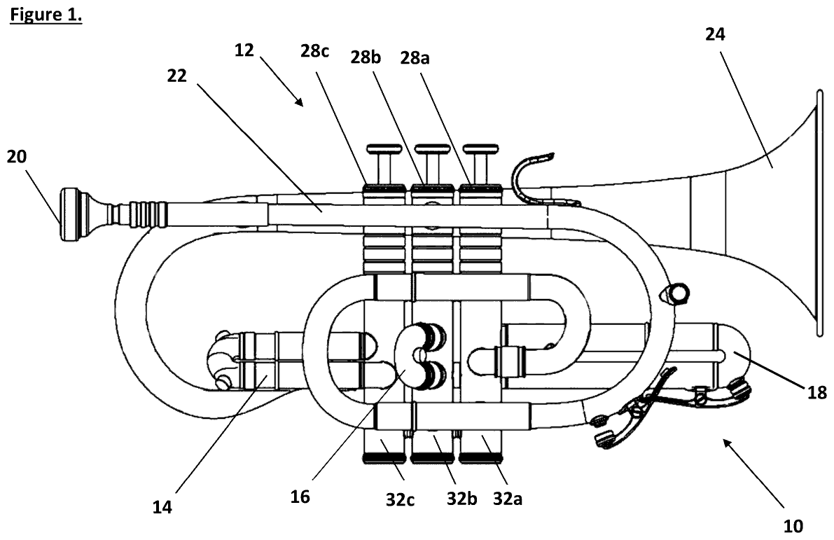

FIG. 1 is an isometric view of an instrument utilising a valve assembly of the present invention;

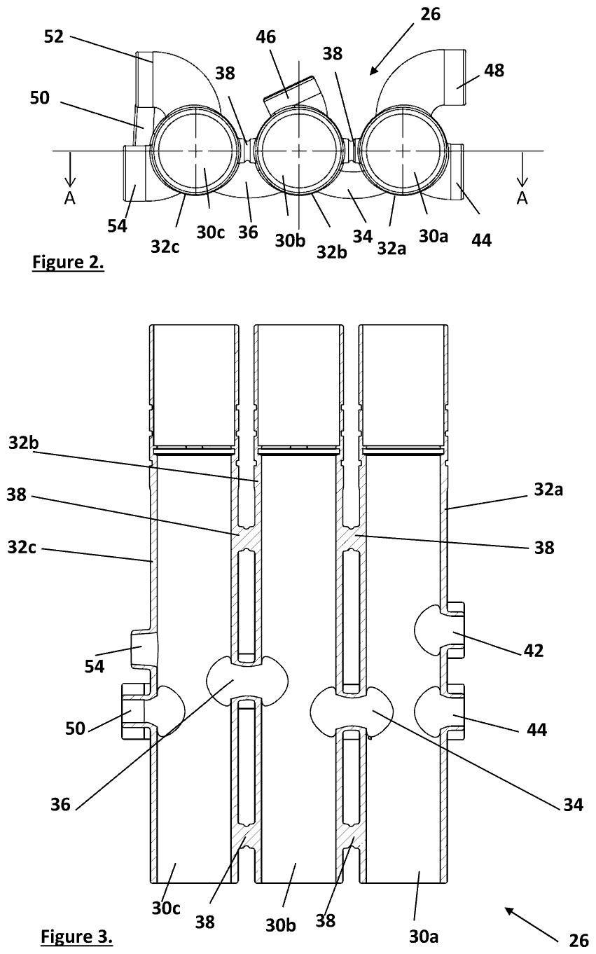

FIG. 2 is a plan view of a valve block used in the valve assembly shown in FIG. 1;

FIG. 3 is a sectional view, along the line A-A, of the valve block of FIG. 2;

FIG. 4 is a front iew of the valve block of FIG. 2;

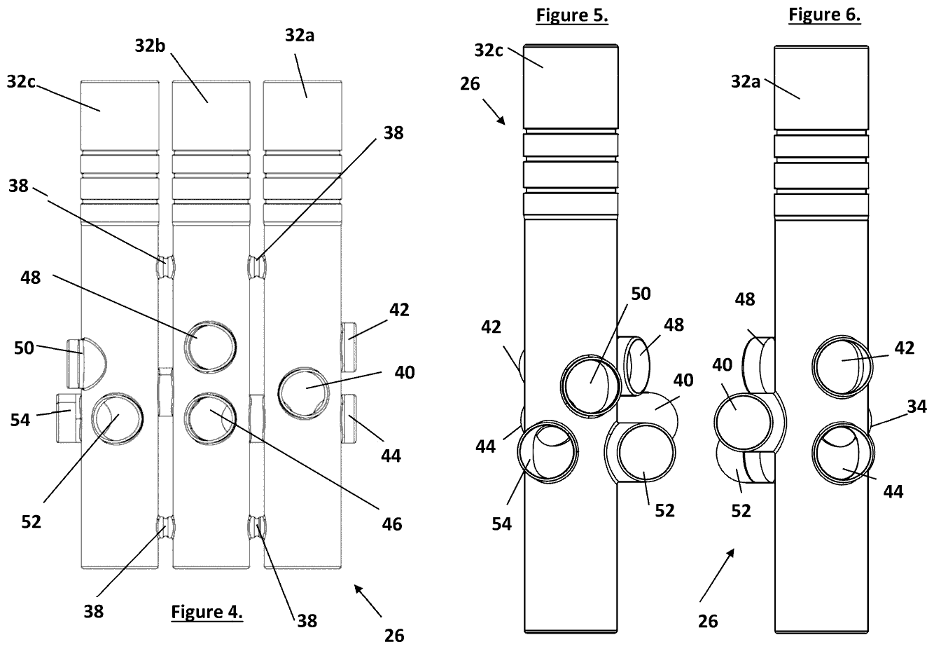

FIGS. 5 and 6 are side views of the valve block of FIGS. 2 and 3;

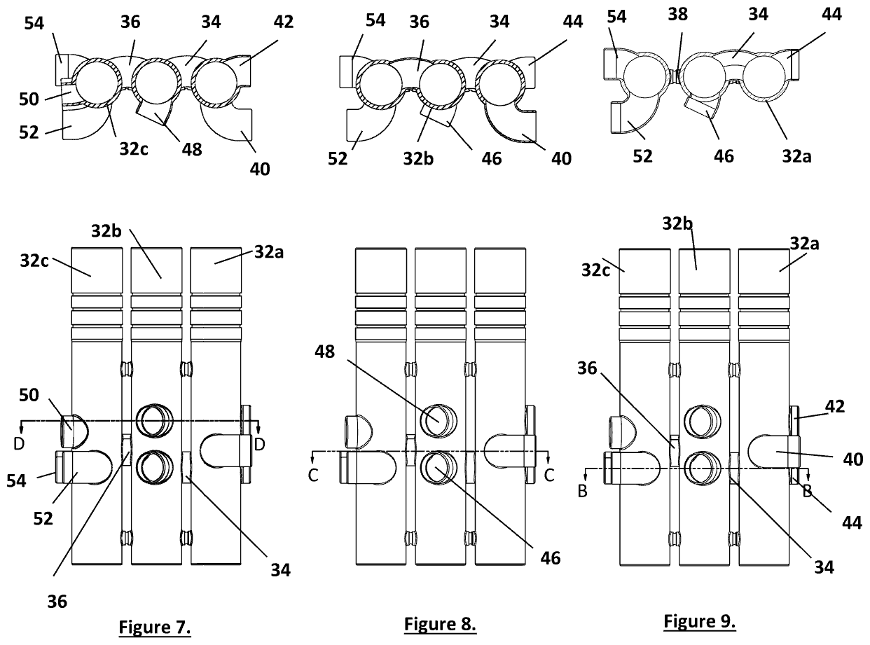

FIGS. 7, 8 and 9 are a series of front and related sectional views, with the sectional views being taken along the lines B-B, C-C and D-D respectively therefore viewing the sectioned valve block from above;

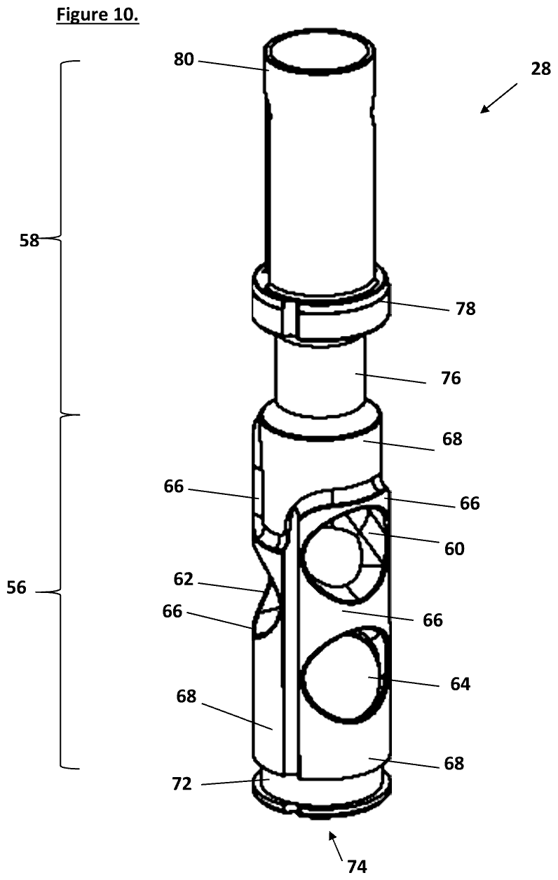

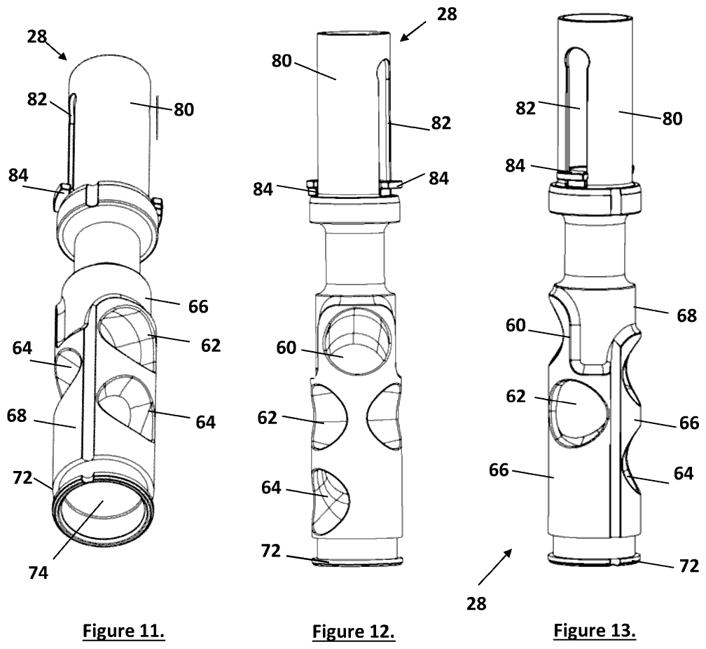

FIGS. 10 and 11 are isometric views, from slightly above and below, of a piston used in the valve assembly shown in FIG. 1;

FIGS. 12 and 13 are side views of the piston of FIGS. 10 and 11.

Referring initially to figure f 1, an example of a musical instrument 10 is shown which incorporates a valve assembly 12. In FIG. 1, the instrument is a Bb Cornet. However, the instrument could be any other instrument which uses a valve assembly 12 including a plurality of sliding pistons and a valve block to determine which of the three valve slides 14, 16, and 18 the air will pass through in turn determining the overall length of air pathway that is being played. Examples of such instruments include, but are not limited to, the trumpet, cornet, flugelhorn, tuba, euphonium, tenor horn, baritone horn, sousaphone, herald trumpets, valved hunting horns and the mellophone.

Other than the valve assembly 12, the remainder of the instrument 10 is of a standard construction using the normal components from the mouthpiece 20 through the lead pipe 22 all the way to the bell 24. The valve assembly 12 has a valve block 26 and a series of pistons 28 which are received within the valve block. In standard brass instruments of the types described above each valve block 26 has three apertures 30 (labelled separately as 30a, 30b and 30c) to receive three pistons 28 (labelled separately as 28a, 28b and 28c). In principle there could be more pistons and apertures in the valve assembly. The purpose of the present invention is to provide a valve block for an instrument which appears visually almost identical to a standard instrument but which has addressed some of the problems with prior art instruments.

With additional reference to FIGS. 2 to 9, the apertures 30 in the valve block 26 are circular in cross-section and are formed in three tubes 32 which have substantially uniform wall thicknesses. The three tubes (labelled separately as 32a, 32b and 32c) are connected by a pair of connecting tubes 34 and 36, with connecting tube 34 joining tube 32a to 32b and connecting tube 36 joining tube 32b to 32c. Also connecting the three tubes are two pairs of reinforcing connectors 38 located above and below the connecting tubes 34 and 36. These reinforcing connectors 38 do not allow any flow of air between the tubes 32 and are provided to reinforce the connection of the tubes together and prevent damage to the connecting tubes 34 and 36. Each of the three tubes 32 has two or three connectors (labelled 40 to 52 which provide an air pathway between the valve tubes, the three valve slides 14, 16, 18, the lead pipe 22 and the pipe that extends to the bell 24. The first connector 40 is connected to the lead pipe 22 and is the first point at which air travelling from the mouth piece 20 enters the valve block 12 through the first valve tube 32a. The second and third connectors 42 and 44 are respectively the inlet and outlet for the first valve slide 14 from the first valve tube 32a. The fourth and fifth connectors 46 and 48 connect the second valve tube 32b to the second valve slide 16 respectively as inlet and outlet. The sixth and seventh connectors 50 and 52 connect the third valve tube 32c to the third valve slide 18 respectively as inlet and outlet. Finally, the eighth connector 54 connects the third valve tube 32c to the pipe that extends to the bell 24.

Turning now to FIGS. 10 to 13, there is shown therein an example of one of the pistons 28 which sit within the valve tubes 32 of valve block 26. The example shown is the piston 28a that sits within aperture 30a. The piston 28 can be described as being in two portions (although it is formed as a single component). There is a lower portion 56 and an upper portion 58. The lower portion 56 contains three ports which determine whether the air passes straight through the valve or it passes through the valve slide associated with that valve. The positions of these holes are the same, or substantially the same, as those of standard instruments of the prior art.

The lower portion 56 of the piston 28 has a curved external surface which is divided into two parts 66 and 68. The first surface portion 66 extends around the ports 60, 62 and 64 and, when the piston is in use inside the aperture 30 of valve tube 32, that first surface engages the internal surface of the valve tube. The second surface portion 68 is located radially inwards of the first surface portion 66 thereby creating a wall 70 that connects the two surface portions. This wall is at least 1 mm in height meaning that the second surface portion 68 is at least 1 mm radially inwards of the first surface portion 66. At the very bottom of the lower portion 56 of the piston 28 is a third surface portion 72 which is radially equal to the first surface portion 66. A recess 74 is located in the underneath of the piston 28 adjacent the third surface portion 72. This recess 74 extends into the piston to a depth just short of the lowermost of the bores 64. The recess is flat in its profile as shown in the figures but can be shaped to approximate the shape of the bore 64.

The upper portion 58 of the piston 28 is in its shape substantially the same as upper portions of pistons of the prior art. It includes a narrow portion 76 which begins immediately above the top of the part of the first surface portion 66 above the uppermost bore 60. Above the narrow portion is a wider portion 78 which has the same diameter as the third surface portion 72 and therefore stabilises the movement of the piston within the valve block preventing any wobbling of the piston in a direction transverse to the piston axis. The narrow portion 76 can be significantly smaller in diameter than the first surface portion 66 as it merely acts to connect the wider portion 78 to the lower portion 56. Above the wider portion 78 is a slotted tube 80 which, in use, contains the springs (not shown) which control the position of the pistons within the valve block and ensure that the pistons return to their default position after being pressed. The tube 80 has side slots 82 which contain sliders 84 which extend outside the diameter of the piston and engage the top of the valve block to facilitate that springing action.

Manufacture of the components of the valve block will now be described. Both the valve block 26 and the pistons 28 are formed by a subtractive manufacturing process such as machining the components from single blocks of a suitable metal material. The materials used are, for example, brass, titanium or lightweight alloys. These materials are simply examples and other materials may also be used and most typically brass is selected for the valve block and titanium or lightweight alloys are used to make the pistons.

The machining of the components from the larger block of metal is achieved using a combination of a 5 Axis CNC lathe with live tooling (for forming the piston) and a multi axis (6-7 axis) CNC machining centre (which is used to make the valve block and can also be used to make the piston). 3D CAD and 2D manufacturing drawings are produced to enable the components to be manufactured. The 3D CAD files are used to create the CNC tool paths and the 2D manufacturing drawing provide the necessary tolerance and surface finish information.

In the machining of the valve block 26, it is important that the connectors 40 to 54 are all formed as part of that machining process. This allows that the three valve slides 14, 16 and 18 can all be attached by a soldering rather than brazing process. Similarly, the lead pipe 22 and the pipe connected to the bell 24 can be soldered to the connectors 40 and 54 respectively. In the prior art, the connectors are attached to the valve block by brazing and then various pipes and slides are soldered to the connectors. As a result of the use of the present invention, the need for brazing as part of the production process for the valve block has been eliminated.

In the machining of the pistons 28, the combined aim of the manufacturing process is to increase the accuracy and consistency of the production of the instrument without significantly changing the weight. This is achieved by machining the product from titanium or lightweight alloys and altering the shape of the piston by removing material that is not performing the function of sealing the air pathway through the piston. This latter aim is achieved by the use of the two different surface portions 66 and 68. More material is removed in the second surface portion 68 which is radially inwards of the first surface portion 66. The more radially outwards first surface portion 66 is required in order to form a seal between the internal surface of the apertures 30 of the valve block 26 adjacent the connectors 40 to 54 where they fit to the ports 60, 62 and 64 in the pistons 28. The material around the edges of the ports is sufficient to ensure that the piston remains coaxial with the bore or aperture 30 of the tubes 32 and is assisted by the third surface portion 72. As can be seen in FIG. 11, the underneath of piston 28, adjacent the third surface portion 72, is also machined away creating the recess 74 further reducing the material used in the piston 28.

In order to further reduce or even eliminate the need for lubricant to be used, the internal surfaces of the bores 30 and external surfaces of the pistons 28 are coated with a ceramic or alternative similar materials which reduce the friction between the engaged surfaces and improves resistance to the corrosive nature of saliva.

It will be appreciated by persons skilled in the art that the above embodiments have been described by way of example only and not in any limitative sense, and that various alterations and modifications are possible without departure from the scope of the protection which is defined by the appended claims. In particular, where various embodiments and aspects of the invention have been described above, features and steps of the apparatus and method are interchangeable between the embodiments and aspects of the invention. For example, where dimensions are indicated in the examples set out above these are examples of ideal measurements but should be taken as being indicative of being essential to the performance of the invention. The embodiment described above and the majority of instruments to which the present invention is used on have three pistons in the valve assembly. However, instruments can be formed with more or less than three valves and the techniques for producing the valve assembly is equally applicable for such instruments.

1. A valve assembly for a brass instrument, the assembly comprising:
a valve block having a plurality of substantially cylindrical apertures for receiving valve pistons therein;
a plurality of valve pistons, wherein each piston is formed by removal of material from a block of metal, each piston is substantially cylindrical, having a curved surface between opposing ends of said cylindrical form and having a plurality of air flow apertures extending between portions of said curved surface, wherein said curved surface has a first surface portion for engaging an internal surface of said valve block apertures and said second surface portions radially inward of said first surface portions, wherein said first surface portions extend around said air flow apertures and said second surface portions are located between said air flow apertures and said ends.

2. A valve assembly according to claim 1, wherein said first surface is radially outwards of said second surface by at least one millimetre.

3. A valve assembly according to claim 1, wherein said valve piston comprises titanium.

4. A valve assembly according to claim 1, wherein said pistons comprise third surface portions located adjacent said ends and radially equal to said first surface portions.

5. A valve assembly according to claim 1, wherein said third surface portions are located distal of finger buttons of said valve assembly.

6. A valve assembly according to claim 1, wherein said first surface portions of said pistons are coated with a ceramic material.

7. A valve assembly according to claim 1, wherein said valve block is formed by removal of material from a block of metal.

8. A valve assembly according to claim 1, wherein said valve block comprises a plurality of pipe connectors to allow connection of said valve blocks to connecting pipes of the instrument by soldering.

9. (canceled)

10. A valve assembly according to claim 1, wherein said internal surface of said cylindrical apertures are coated with a ceramic material.

11-21. (canceled)

22. A brass instrument comprising:
mouth pipe;
a valve assembly according to claim 1;
a bell; and
a plurality of pipes connecting the mouth pipe to the bell via the valve assembly.

23. A method of making a piston for a valve assembly for a brass instrument, comprising:
removing material from a block of metal to form a substantially cylindrical piston, having a curved surface between opposing ends of said cylindrical form wherein said removal of material forms a first surface portion of said curved surface for engaging an internal surface of a valve block and further removal of material forms second surface portions, radially inward of said first surface portions;
forming a plurality of air flow apertures extending between portions of said curved surface, wherein said first surface portions extend around said air flow apertures and said second surface portions are located between said air flow apertures and said ends.

24. A method of making a valve block for a valve assembly for a brass instrument comprising removing material from a block of metal to form a plurality of substantially cylindrical apertures for receiving valve pistons therein and removing material to form a plurality of pipe connectors to allow connection of said valve blocks to connecting pipes of the instrument by soldering.

25. A method of making a valve assembly for a brass instrument comprising:
making a plurality of pistons according to claim 23;
making a valve block by removing material from a block of metal to form a plurality of substantially cylindrical apertures for receiving valve pistons therein and removing material to form a plurality of pipe connectors to allow connection of said valve blocks to connecting pipes of the instrument by soldering; and
inserting said pistons into said valve block.

26. A method of making a brass instrument comprising:
mouth pipe;
making a valve assembly according to claim 25;
attaching a mouth pipe to said valve assembly; and
attaching a plurality of pipes connecting the valve assembly to a bell.

27. A piston for a valve assembly for a brass instrument, the piston comprising: a substantially cylindrical curved surface extending between opposing ends of said cylindrical form and has a plurality of air flow apertures extending between portions of said curved surface, wherein said curved surface as a first surface portion for engaging an internal surface of a valve block and said second surface portions radially inward of said first surface portions, wherein said first surface portions extend around said air flow apertures and said second surface portions are located between said air flow apertures and said ends.

28. A piston according to claim 27, wherein said valve piston comprises titanium.

29. A piston according to claim 27, wherein said pistons comprise third surface portions located adjacent said ends and radially equal to said first surface portions.

30. A piston according to claim 27, wherein said third surface portions are located distal of finger buttons of said valve assembly.

31. A piston according to claim 27, wherein said first surface portions of said pistons are coated with a ceramic material.

32. A piston according to claim 27 wherein the piston is formed by removal of material from a block of metal.
